(19) United States
(12) Patent Application Publication
(10) Pub. No.: US 2016/0209591 A1
(43) Pub. Date: Jul. 21, 2016

(54) METHOD FOR MANUFACTURING OPTICAL MEMBER, AND OPTICAL MEMBER, TRANSPARENT MEMBER FOR FORMING OPTICAL MEMBER, OPTICAL WAVEGUIDE AND OPTICAL MODULE

(71) Applicant: HITACHI CHEMICAL COMPANY, LTD., Tokyo (JP)

(72) Inventors: Daichi SAKAI, Tsukuba (JP); Masao UCHIGASAKI, Tsukuba (JP); Toshihiro KURODA, Tsukuba (JP)

(73) Assignee: HITACHI CHEMICAL COMPANY, LTD., Tokyo (JP)

(21) Appl. No.: 14/914,678

(22) PCT Filed: Aug. 30, 2013
(86) PCT No.: PCT/JP2013/074009

§ 371 Date: Feb. 26, 2016

(51) Int. Cl. G02B 6/138; G02B 6/122; G02B 6/136; B29D 11/00

(52) U.S. Cl. CPC G02B 6/138; B29D 11/00701; G02B 6/1221; G02B 6/136; B29K 2033/04

(57) ABSTRACT

The present invention provides a method for manufacturing an optical member and an optical waveguide having a low optical loss. The provided method is capable of highly accurately controlling the positional configuration of refractive index distribution in the surface layer, including its vicinity, and the center portion of the core pattern in a transparent member. The method for manufacturing the optical member by the present invention has a Process A, in which the transparent member is exposed to a solution and thereby the refractive index of the surface layer of the transparent member exposed to the solution is substantially lower than that of the center portion of the transparent member not exposed to the solution. The substantial lowering of the refractive index of the surface layer is achieved by making the refractive index regulating agent exert its function by being included in the surface layer of the transparent member. The optical waveguide by the present invention has such a feature that surface layers of two or more sides on the circumference of the core pattern forming the core part have a refractive index lower than that of the center portion of the core pattern. The surface layer includes a refractive index regulating agent for lowering the refractive index. Further, a lower clad layer or an upper clad layer, or both, are provided outside the surface layer of low refractive index, wherein the refractive index of these clad layers are lower than that of the surface layer.

### TECHNICAL FIELD

The present invention relates to a method for manufacturing optical member; and optical member, transparent member for forming optical member, optical waveguide, and optical module.

### BACKGROUND OF THE INVENTION

Antireflection members have been used for various applications. In particular, they are used in the main bodies of devices such as displays or in certain members with being pasted thereon in a style of film. In general, the antireflection function of an antireflection film is provided by a multiple-layer of transparent material formed on a transparent substrate. The multiple-layer is composed of an alternate lamination of a high refractive index part and a low refractive index part, each of which parts is made of the transparent material such as metallic oxide. The multiple-layer structure of this kind can be formed generally by a dry deposition method such as the physical vapor deposition (PVD) and the chemical vapor deposition (CVD). These methods have an advantage in that the film thicknesses of the low refractive index part and the high refractive index part can be accurately controlled.

In addition, with the increase of information volume, development of the optical interconnection techniques employing light signal is pushed forward for not only the field of communication such as trunk lines and access systems but also the information processing in routers and servers. Specifically, the development of the opt-electrical composite circuit board that combines the optical transmission line to an electrical circuit board has been being made to actualize use of light in the short-haul signal transmission between circuit boards in a router or a server, or within a circuit board. As the optical transmission line for this purpose, use of an optical waveguide is preferable, because the optical waveguide has a higher freedom in wiring and a highly-densified feature compared to an optical fiber. Among optical waveguides of various kinds, the optical waveguide that uses polymer, which is excellent in workability and economy, is promising.

As the suitable optical waveguide for that, Patent Literature 1 for example describes an optical waveguide. The described optical waveguide has a construction manufactured in a manner such that a lower clad layer is formed on a carrier film by curing, a resin for forming core pattern is build up on the lower clad layer, the composition thus made up is exposed and etched to form a core pattern, and then an upper clad layer is laminated thereon.

### Patent Literature 1

Japanese unexamined patent application publication No. 2003-195081

### SUMMARY OF THE INVENTION

However, to make an antireflection member by above-stated dry deposition method needs processing the member under vacuum. Therefore, this requirement brings a low productivity problem and further brings anxiety about that exposure to vacuum may damage a transparent member. Moreover, there was a fear of a positional variation of the distribution of the refractive index when a film has a bent shape (including a bend occurred during manufacturing process), a complicated shape, or an intricate shape.

In addition, in a case where the core pattern of an optical waveguide is formed by etching like Patent Literature 1 describes, it was anxiety that degradation of the optical loss of the light propagating in the core pattern would occur due to some disturbance such as interfacial roughness between the clad and the core pattern, and irregularity of refractive index in the core pattern attributable to the etchant.

The present invention has been made in a view to solve the above problems. An object of the present invention is to provide a method for manufacturing an optical member and to provide an optical waveguide. The invented method has excellent mass productivity and is capable of controlling positionally accurately the refractive index of the surface layer, including its vicinity, and the center portion of a transparent member. The invented optical wave guide is an optical waveguide comprised of a lower clad layer, a core pattern, and an upper clad layer; the optical wave guide gains a low optical loss by using the optical member produced by the invented manufacturing method.

The inventors of the present invention have made intensive studies to solve the above-stated problems. As a result of the study, the inventors have found a method for manufacturing an optical member as a solution to the above-stated problem. In the method, the transparent member to be used is given a specific feature. The method for giving the specific feature includes for example a process that exposes the transparent member to a solution to make the refractive index of the exposed portion of the transparent member substantially lower than that of the center portion of the transparent member, where the center portion is a non-exposed portion. This process is referred to as a Process A. The inventors further have found that a use of such transparent member for forming the optical member having above-stated feature as the member for forming core pattern in an optical waveguide is also a solution to the problem. The present invention has been made based on this knowledge.

That is, the present invention relates to the following.

(1) A method for manufacturing an optical member comprising a Process A, wherein the Process A includes the step of exposing a transparent member to a solution to make the refractive index of the surface layer of the transparent member, which layer is exposed to the solution, substantially lower than that of the center portion of the transparent member, which center portion is not exposed to the solution.

(2) A method for manufacturing an optical member according to the method described in the clause (1) above, wherein the transparent member is impregnated with the solution when exposed to the solution in the Process A.

(3) A method for manufacturing an optical member according to the method described in the clause (1) or the clause (2) above, wherein the solution includes a refractive index regulating agent that substantially lowers the refractive index of the surface layer of the transparent member by the solution's being included in the surface layer of the transparent member.

(4) A method for manufacturing an optical member comprising a Process A′, wherein the Process A′ includes the steps of including a refractive index regulating agent that substantially lowers the refractive index of a transparent member in the surface layer of the transparent member; and thereby making the refractive index of the agent-including portion in the surface layer substantially lower than that of the center portion of the transparent member, wherein the center portion does not include the refractive index regulating agent.

(5) A method for manufacturing an optical member according to the method described in any one of the clauses (1) to (4) above, wherein the transparent member is an etchable transparent member by an etchant; the method further comprises a Process B that performs a patterning process by etching; and the Process B is performed simultaneously with the Process A or the Process A′ or is carried out before the Process A or the Process A′.

(6) A method for manufacturing an optical member according to the method described in any one of the clauses (1) to (5) above, wherein the transparent member is a transparent resin; and the refractive index regulating agent is a monovalent cation.

(7) A method for manufacturing an optical member according to the method described in the clause (6) above, wherein the solution is an alkaline solution.

(8) A method for manufacturing an optical member according to the method described in the clause (6) or the clause (7) above, wherein the monovalent cation is at least one of ions selected from the group consisting of potassium ion and sodium ion.

(9) A method for manufacturing an optical member according to the method described in any one of the clauses (6) to (8) above, wherein the transparent resin is a light-sensitive resin; and the method further comprises a Process C that performs irradiation of activation light ray with which the light-sensitive resin is photocurable, wherein the Process C is carried out before the Process A or the Process A′, or the Process B; or before the Process A or the Process A′, and the Process B.

(10) A method for manufacturing an optical member according to the method described in any one of the clauses (6) to (9) above, wherein the method further comprises a Process D′ that thermally cures the transparent resin after the Process A or the Process A′.

(11) A method for manufacturing an optical member comprising a Process D that thermally cures a transparent resin and makes the refractive index of the surface layer, including its vicinity, of the transparent resin substantially lower than that of the center portion of the transparent resin.

(12) A method for manufacturing an optical member according to the method described in the clause (10) or the clause (11) above, wherein the transparent resin includes at least: a base resin (A) having a thermal polymerizable functional group, and a thermal polymerizable compound (B).

(13) A transparent member for forming an optical member to be used in the method for manufacturing the optical member according to the method described in any one of the clauses (1) to (12) above.

(14) An optical member obtained by the method for manufacturing the optical member according to the method described in any one of the clauses (1) to (12) above.

(15) An optical waveguide having a core part and a clad part, wherein the optical waveguide has a surface layer at least on a part of periphery of a core pattern that forms the core part, the surface layer having a refractive index lower than that of the center portion of the core pattern.

(16) An optical waveguide according to the clause (15) above, wherein the optical waveguide has a laminated construction comprised of a lower clad layer, the core pattern, and an upper clad layer, and the lower clad layer or the upper clad layer, or both, having a further-low refractive index is or are provided outside the surface layer having the low refractive index.

(17) An optical waveguide according to the clause (15) or the clause (16) above, wherein the core pattern having two or more sides on the circumference thereof is such a core pattern as includes at least two sides of both the side walls.

(18) An optical waveguide according to the clause (16) or the clause (17) above, wherein the difference in the refractive index between the low refractive index portion and the lower clad layer or the upper clad layer, or both, is larger than the difference in the refractive index between the center of the core pattern and the low refractive index portion of the circumference of the core pattern.

(19) An optical waveguide according to any one of the clauses (15) to (18) above, wherein the core pattern is formed by the transparent member for forming the optical member defined in the clause (13) above.

(20) An optical waveguide according to any one of the clauses (15) to (19) above, wherein the surface layer includes a refractive index regulating agent for lowering the refractive index.

(21) An optical module that uses the optical waveguide defined in any one of the clauses (15) to (20) above.

(22) A transparent member for forming a core pattern of an optical waveguide that has a lamination of a lower clad layer, the core pattern, and an upper clad layer, wherein, in forming the core pattern, a surface layer having a refractive index lower than that of the center portion of the core pattern is substantially formed on two or more sides on the periphery thereof.

The invented method for manufacturing an optical member is excellent in the mass productivity and is capable of controlling positionally accurately the refractive index of the surface layer, including its vicinity, of the core pattern and the center portion of the transparent member. Thus, the method is a suitable method for manufacturing an optical waveguide. In addition, the invented optical waveguide offers a low optical propagation loss by the use of a specific core pattern.

### BRIEF DESCRIPTION OF THE DRAWINGS

FIGS. 1A and 1B are a cross-sectional view of the invented optical waveguide.

### DETAILED DESCRIPTION OF THE PREFERRED EMBODIMENTS

One method for manufacturing an optical member by the present invention includes a Process A. The Process A exposes the transparent member to a solution to make the refractive index of the exposed portion of the transparent member substantially lower than that of the center portion of the transparent member, where the center portion is a non-exposed portion. Thereby, a transparent member having portions with different refractive index can be formed, which is applicable to a use for an antireflection member, the core pattern in an optical waveguide, which will be mentioned later, and other similar purposes. The term “transparent” used in the present invention means being transparent to the wavelength of the light to be used in the invented optical members; that is, a transparency that practically does not affect the propagation of used light is suffice. The expression “substantially lowers the refractive index” means not only that exposing the transparent member to a solution lowers the refractive index of the portion exposed to the solution but also that undergoing a successive post-processing produces the difference in refractive index resulting in the relatively lowered refractive index finally. The process that causes the difference of the refractive index may be performed immediately after this Process A or may be performed after a Process B for patterning or after a Process D for the thermal hardening, which will be mentioned later.

In the present invention, the substantial lowering of the refractive index using a solution brings an advantage in that the refractive index of the exposed portion of the optical member can be controlled under a uniform condition. In addition, since the exposed portion comes to have a low refractive index, the refractive index of the opposite face of an object can be lowered by performing the Process A after the laminating of the transparent member on the object, for example.

With respect to the type of the transparent member, there is no particular limitation; any material is usable as long as the material is capable of producing the difference of the refractive index. As a method of producing the difference in the refractive index of the transparent member using a solution includes, for example:

(a) Creating a sparse portion, in terms of sparse or dense, in the exposed portion of the transparent member using a solution to produce the difference of the refractive index;

(b) Including a high refractive index component, which is soluble in a solution, in the transparent member in advance to produce the difference of the refractive index by dissolving the high refractive index soluble component by a solution; and

(c) Exposing the transparent member to a solution that includes a low refractive index component, whose refractive index is lower than that of the transparent member, to impregnate the transparent member with the solution, and fixing the low refractive index component in the transparent member as the refractive index control agent, thereby producing the difference of the refractive index.

Other than these, as will be mentioned later, the following method may be one of another methods:

(d) Exposing to a refractive index regulating agent that is capable of changing the molecular geometry or the molecular network pattern to impregnate with such agent for producing the difference of the refractive index between the exposed-impregnated portion and the other portion not exposed.

In this method (d), the molecular geometry and the molecular network pattern can be changed by undergoing a successive post-processing. Any of those methods for producing the refractive index difference listed above may be used. The important matter in the present invention is the substantial lowering of the refractive index of the exposed-impregnated portion with the solution.

The optical member thus obtained should be transparent and shall not cause diffusion or dispersion with respect to the light passing through the member. For example, the prevention as much as possible of the inclusion of a substance that has an absorption band with respect to the light to be used (a factor of lowering transmission) and voids (a factor of causing diffusion and dispersion) in the transparent member is preferable from viewpoints of transparency improvement and haze elimination. Particularly, voids bring about difficulty in regulating the refractive index around them; it is therefore preferred not to include or not to produce voids.

It is preferable to include a solution that substantially lowers the refractive index in the transparent member at the Process A. The term impregnation means to be permeated to the depth and in the direction as desired. The proper regulating of the concentration, quantity, time, temperature, pressure, etc. of the solution for exposure makes it possible to control the distribution profile of the refractive index in the depth-wise. In the method for manufacturing an optical member in the present invention, the refractive index distribution in the optical member from its surface to the center portion (that is in the exposure direction) is formed usually with a gradation, but the refractive index may be varied to a predetermined depth at a uniform rate. Particularly in the case, as will be mentioned later, where the transparent member is resin, the distribution style tends to take the former style because the depth and quantity of the impregnation by the exposure to the solution tend to be in a reversely proportional relation. In addition, the expression “the solution that can substantially lower the refractive index” does not mean a liquid that is liquid-state at room temperature at the manufacturing of a distributed refractive index type optical part and is consisting only of low refractive index monomer group to be left as a residual in the surface layer, including its vicinity, of the transparent member. In the present invention, the “the solution that can substantially lower the refractive index” means water, organic solvent, compound liquid of them, etc. which work as a solvent but does not remain in the surface layer, including its vicinity, of the transparent member even after undergoing post-processes; or means compound liquid of above-stated matters with another component (for example; alkaline component, acidic component, additional component for solution control, and refractive index control agent, which will be mentioned later, etc.)

The present invention has an advantage in that the refractive index of the surface layer can be lowered with the shape of the transparent member maintained adequately, because adverse effect attributable to the dissolution or swelling of the transparent member can be avoided by using a solution containing water as the main component at the Process A. Further, it becomes possible to obtain the pattern shape highly accurately by processing with the above-stated aqueous solution in the Process B, which will be mentioned later.

In the present invention, to include the refractive index regulating agent in the transparent member partly can vary the refractive index of the intended portion thereof. The present invention has a feature in that the including of the refractive index control agent particularly in the surface layer of the transparent member makes the function of the substantial lowering of the refractive index on the surface layer work. In addition, it is preferable from viewpoints of transparency improvement and haze elimination that the refractive index control agent is not such a substance as has an absorption band with respect to the light to be used (a factor of lowering transmission) and does not include voids (a factor of causing diffusion and dispersion).

It is preferable that the solution includes the refractive index regulating agent that provides an effect of the substantial lowering of the refractive index of the transparent member. By this inclusion of the refractive index regulating agent, the exposure to and the impregnation with solution brings about a simultaneous exposure and impregnation with respect to the transparent member, facilitating an effective forming of the portion whose refractive index is relatively low.

Another method for manufacturing an optical member by the present invention comprises a Process A′, wherein the Process A′ includes the steps of including a refractive index control agent, which substantially lowers the refractive index of a transparent member, in the surface layer thereof, and thereby making the refractive index of the agent-including portion in the surface layer substantially lower than that of the center portion of the transparent member, wherein the center portion does not include the refractive index control agent. The Process A′ includes both of the two methods listed below. One method is a method in which the refractive index control agent is made included in the outer layer of the transparent member in advance at the stage of manufacturing the transparent member. The other method is a method in which the transparent member is prepared and then is exposed to a solution to allow the solution to be impregnated in the surface layer of the transparent member. In the later method, it may be an alternative to make the refractive index of the surface layer eventually relatively-low through the post-processing such as thermal hardening.

Thereby, the transparent member having different refractive index portions, as with by the Process A, can be obtained. Consequently, the transparent member so formed is applicable to the use for such as antireflection films and the core pattern of an optical waveguide, which will be mentioned later.

Where the transparent member is a transparent member etchable by etchant and the member is to undergo the Process B, which is the patterning process by etching, the transparent member can be worked into a desired shape. Further, by performing the above-stated Process A or the Process A′ at the same time or after the Process B of patterning the transparent member, it becomes possible to lower the refractive index of the side wall of surface layer including its vicinity. In addition, where the transparent member is an etchable material, multiple transparent members can be processed in a lump; this offers an excellent productivity.

With respect to the type of the transparent member, there is no particular limitation; any material is usable as long as the material is capable of substantially lowering the refractive index by exposure to a solution or by inclusion of the refractive index regulating agent. A transparent resin is preferable as the transparent member from the viewpoint of easiness of processing. Where the refractive index control agent is cation, the exposure and the impregnation are easy. Where the solution to which the transparent member is exposed is alkaline solution, handling is easy. The combination of these is therefore preferable in that the effects of these manufacturing methods are easily exhibited.

With the above-stated combination, an optical member can be easily and efficiently manufactured by exposing a transparent member, which comprises a resin composition in which the cation works as the refractive index regulating agent, to a cation-including solution as an alkaline solution to impregnate the exposed transparent member with cation. A concrete example of the resin composition that is capable of achieving the present invention is mentioned later.

The above-stated cation is preferred to be positive-charged ions, because such ions are easy in exposure and impregnation with respect to the transparent resin and are easily fixed by ionic bonding, or the like, within the transparent resin. Further, when the cation is monovalent cation, the density increase due to the crosslinking by ion binding in the transparent resin is suppressed and it becomes easy to substantially lower the refractive index. For the case of bivalent or more-valence cation, it is difficult to substantially lower the refractive index, because such cation is accompanied by increase of the density due to products from the crosslinking reactant and the multivalent cation. Among monovalent cations, potassium ion or sodium ion or, both, in particular are more preferable, because such cations are easy to handle and usually become a transparent resin of low hygroscopicity compared to other alkaline metal ions.

In the present invention, a monofunctional compound (monomer) or a compound (monomer) having a polymerizable functional group whose hardening reaction is slower than that of the center portion of the transparent member may be used as the refractive index regulating agent that has the same function as the one in the above-stated cation. For example, the monofunctional compound (monomer) is adsorbed on or impregnated into the surface layer of the transparent member by exposing the transparent member to the solution comprised of an organic solvent that includes monofunctional compound (monomer). The successive process of photo-curing or thermal-curing lowers the crosslinking density in the surface layer of the transparent member; thereby, the refractive index of that portion becomes relatively-low compared to that in the non-impregnated portion. Likewise, when a compound (monomer) having a polymerizable functional group whose curing reaction is slower than that of the center of the transparent member is used, hardening in the surface layer of the transparent member becomes also slower and the crosslinking reaction is suppressed; thus, the portion whose refractive index is relatively-low compared to the center of the transparent member can be formed.

As the above-stated monofunctional compound (monomer), a compound that has one ethylenically unsaturated group, such as acrylate and methacrylate, in one molecule or an epoxide compound that has one epoxy group may be listed for example. When the transparent member used in the present invention includes at least a substance such as polyfunctional acrylate and methacrylate that have two or more ethylenically unsaturated group, a compound that includes only one group selected from the set of groups consisting of addition polymerizable allyl group, epoxy group, and isocyanate group that form urethane bond, can be used as a compound (monomer) having a polymerizable functional group whose curing reaction is slower than that of the center portion of the transparent member, because the reaction of the group in the set is slower than that of the above-stated substance contained in the transparent member. In addition, when these compounds are low refractive index materials, the use of these materials as the refractive index regulating agent gives a more enhanced effect of the substantial lowering of the refractive index. Compounds that have such function includes, for example, monofunctional compound (monomer) that does not include aromatic ring nor alicyclic ring, or compound (monomer) that includes polymerizable functional group, whose curing reaction is slow. Other than the above, such a compound as includes elemental fluorine may be used.

When the transparent member is transparent resin, it is more preferable that the transparent resin is light-sensitive resin. In addition, it is further preferable to provide a Process C that irradiates an activation light ray with which the light-sensitive resin is photocurable, wherein the Process C is carried out before the Process A or the Process A′, or the Process B; or before the Process A or the Process A′, and the Process B. Thereby, even though exposing to solution (aqueous solution, alkaline solution, or organic solvent) is performed, the photo curing by the activation light ray still advances, which means the solution resistance is improved. Further, the etchant resistance at the time of patterning by etching is also improved. When an identical liquid (mixed solution is also acceptable) is used as both the solution and the etchant, the Process A and the Process B can be performed simultaneously and gains improvement in workability and mass productivity.

Another method for manufacturing an optical member by the present invention has the Process D. The Process D comprises the steps of, when the transparent member is transparent resin and the transparent member is thermally curable, curing the transparent resin thermally, and making the refractive index of the surface layer, including its vicinity, of the transparent resin after the thermal hardening substantially lower than that of the center portion of the transparent resin after the thermal-curing. The material for the transparent resin used in this case is preferred to be the selection from such a transparent resin that the refractive index of the surface layer, including its vicinity, after the curing can be substantially relatively-lowered by the thermal-curing compared to the refractive index of the center portion. The difference of the refractive index may be produced either by the suppressing of the thermal-curing of the surface layer of the transparent resin (function of inhibiting the curing by oxygen, for example) or by the exposing-impregnating of the refractive index regulating agent with respect to the surface layer of the transparent resin in advance as stated above. In the former procedure of processing, controlling simply the ambient atmosphere at the time of thermal-curing the transparent resin can suppress the curing of the surface layer, including its vicinity, of the transparent resin; therefore, the refractive index of the surface layer, including its vicinity, becomes lower than that of the center portion. In the later procedure of processing, it is preferable to use a refractive index control agent that is capable of thermally changing the crosslinking network to a state sparser than the center portion, to suppress the crosslinking. In the present invention, the changing of the crosslinking network and the suppressing of the crosslinking are interpreted as the suppression of curing in a broad meaning. Producing the difference of the refractive index by such suppression of curing facilitates the controlling of the refractive index and permits highly accurate positional control of the refractive index; this means that the later processing is preferable. The material composition that can exhibit such states will be mentioned later.

The difference of refractive index produced by the thermal-curing makes a member be capable of maintaining the difference of refractive index stably even though the member is to undergo heating process at a later processing stage. Further, even in the case where the difference of refractive index is to be produced before the Process D, likewise in the former case, such curing procedure makes the member be capable of maintaining the difference of refractive index stably even though the member is to undergo re-heating at the processing stage after the heating process (the Process D). In addition, the producing of the difference of refractive index by the thermal-curing is more preferable because it facilitates ensuring the difference. From the viewpoint stated above, it is still more preferable that the change in the crosslinking network generates the difference of refractive index that is attributed to the material composition.

It is preferable to provide a Process D′ after the Process A or the Process A′, wherein the Process D′ is a process of the thermal-curing of the transparent resin. Applying the thermal-curing process leads to curing of both the unreacted photo-cured component and the thermal-cured component, and further, the process can fix the refractive index control agent used in the exposure and impregnation to a certain degree. This Process D′ may be the Process D stated above.

As examples of transparent resin used as the transparent member in the present invention, the following substances are preferable: a base resin (A) having thermal polymerizable functional group, and a transparent resin (B) having at least thermal polymerizable compound. In this case, it becomes possible to produce the difference of refractive index by the exposure to and impregnation of, for example, such a substance as suppresses the crosslinking in the substances (A) and (B), using such substance as the refractive index regulating agent. Particularly, it is preferable that the substance (A) includes carboxyl group in its molecule, and the substance (B) includes, in its molecule, epoxy group or similar group which thermally crosslinks with the carboxyl group in the substance (A); and is preferable that the refractive index regulating agent is such a substance as suppresses the crosslinking reaction between the carboxyl group and the epoxy group. More specifically, the crosslinking reaction between the carboxyl group and the epoxy group can be suppressed by using the carboxyl group and the carboxyl group salt as the above-stated cation. This suppression of the crosslinking reaction causes the exposed-impregnated surface layer to be the two-component system of crosslinked matters of the substance (A) and the substance (B), and also causes the center portion, which is not suppressed with respect to the crosslinking reaction, to be one-component system of a crosslinked matter of the substance (A) with the substance (B). The difference in the number of the component systems influences the material density. Generally, the density tends to decrease as the number of component systems increases. Therefore, the refractive index of the center portion becomes high and that of the surface layer becomes low. In addition, inclusion of ion such as cation generally causes the polarization to be large and the refractive index tends to become high (the refractive index has an approximate first order correlation with the material density and the polarization); however, it is possible to lower the refractive index when a resin composition in which the crosslinking density dominantly contributes to the refractive index is used, even if ion such as cation is included. This effect is significant when monovalent cation is used as cation.

When producing the difference of refractive index using the thermal-curing in the Process D is intended, it is preferable that the refractive index after the thermal-curing (this corresponds to the one in the center portion) is higher than that after the light exposure (before thermal-curing) by 0.003 or more, more preferably by 0.005 or larger, moreover preferably by 0.008 or over. This being preferable comes from the fact that the hardening inhibition by the heat influences greatly the refractive index.

The following details the preferable optical waveguide as a specific example of the optical member.

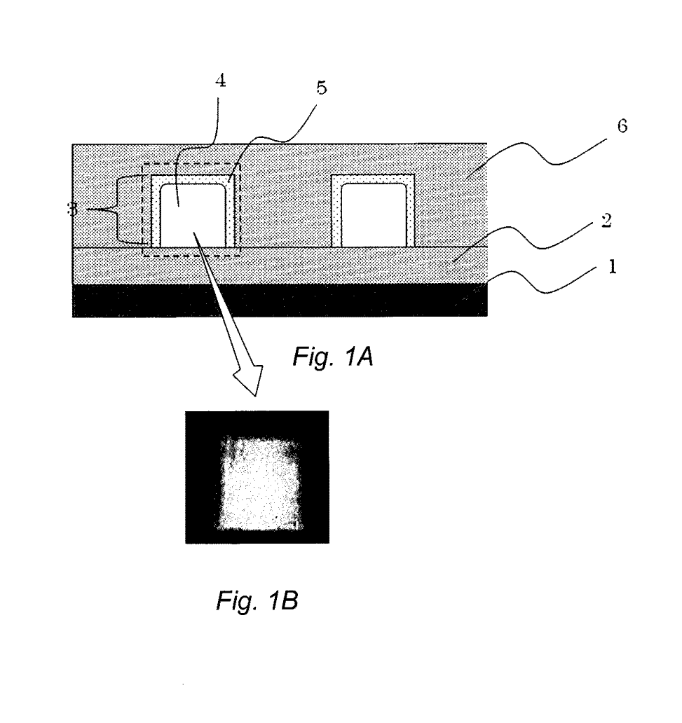

FIGS. 1A and 1B show an optical waveguide by the present invention. FIG. 1A is an illustration schematically showing the cross-section of the optical waveguide. FIG. 1B is an enlarged photograph showing one part of the cross-section of the core part (enclosed by a dotted line) formed on the optical waveguide. As FIGS. 1A and 1B shows, the optical waveguide by the present invention is comprised of a lower clad layer 2 formed on a substrate 1, a core pattern 3, and an upper clad layer 6, wherein two or more sides of the circumference of the core pattern 3 (that is, two or more sides among four sides of the rectangle which is the cross-section of the core pattern) has a low refractive index portion 5 having a refractive index lower than that of a core pattern center portion 4; and the lower clad layer 2 or the upper clad layer 6, or both, are provided outside the low refractive index portion 5.

In the present invention, the circumference of the core pattern 3 means an “inside” area of the periphery of the core pattern 3. At least two or more sides on the circumference have the low refractive index portion 5 the refractive index of which is lower than that of the core pattern center portion 4. Thereby, the light propagating in the core pattern tends to travel within the core pattern center portion 4 enabling lowering the optical loss. Further, the lower clad layer 2 and the upper clad layer 6 are provided outside the low refractive index portion 5, wherein the refractive index of the lower clad layer 2 and the upper clad layer 6 is more-lower. With this configuration, the leakage component in the light propagating in the core pattern 3 to the outside the low refractive index portion 5 can be effectively confined within the core pattern 3. In the optical waveguide of this style of configuration, the light propagating in the core pattern 3 of a straight shape, for example, tends to travel within the core pattern center portion 4 with a low optical loss. The light leakage to the outside of the core pattern 3 due to its bending is totally reflected at the interface between the core pattern 3 and the lower clad layer 2 or the upper clad layer 6, wherein the difference of the refractive index at the interface is larger; thus, the optical loss due to such light leakage hardly occurs.

From the above, the two sides are preferred to be the both side walls of the core pattern 3. When it is three sides or more, the above-stated effect occurs on the three sides or more places; therefore, it is more preferable because attaining more-lower optical loss becomes realizable.

In addition, it is preferable that the difference of refractive index between the low refractive index portion 5 and the lower clad layer 2 or the upper clad layer 6, or both, is larger than the difference of refractive index, which is expressed by the formula shown below, between the core pattern center portion 4 and the low refractive index portion 5 around the core pattern. This comes from the fact that the leakage component in the light from the low refractive index portion 5 can be effectively confined within the core pattern 3.

Difference of refractive index=(n₁²−n₂²)^{1/2}/(2×n₁²) {Formula 1}

where n₁ and n₂ are the refractive index of the high refractive index portion and the low refractive index portion respectively.

No particular limitation is imposed on the method for forming the core pattern for obtaining the above-mentioned optical waveguide. However, the optical member and the method for manufacturing an optical member by the present invention stated above are suitable for the method for forming the core pattern. Particularly, using the same substance as the solution and the etchant allows forming the core pattern and producing the index difference in the core pattern at the same time.

The transparent member for the core pattern forming used in such forming process is a substance that is capable of substantially producing a low refractive index portion on two or more sides of the surface layer on the circumference when the core pattern was formed, wherein the refractive index of the surface layer is lower than that of the center of the core pattern. For example, a dry film of the above-stated base resin (A) having a thermal polymerizable functional group, and the transparent resin (B) having at least a thermal polymerizable compound, may be listed for that purpose.

FIGS. 1A and 1B show a representative example of the optical waveguide by the present invention. The optical waveguide by the present invention, however, is not limited only to the film-shaped waveguide as shown in FIGS. 1A and 1B. For example, the present invention is applicable to an optical waveguide having a configuration of an ordinary optical fiber style having a core part and a clad portion. This application can manufacture an optical waveguide, wherein at least a part of the circumference of the core pattern, which forms the core part, has a surface layer with a refractive index lower than that of the center portion of the core pattern. In addition in the optical waveguide shown in FIGS. 1A and 1B, an optical waveguide of a film-like shape, having no lower clad layer 2, can be a practicable style. In this style, the substrate 1 works at the same time as the lower clad layer; as the substrate 1 therefore, not only hard type substrates such as silicon substrate, glass substrate, or glass-epoxy resin substrate, but also film substrates may be used.

The optical waveguide by the present invention can be used as an optical module that is coupled optically to an optical fiber, a light-emitting element, or a light-receiving element.

The following details each of the members and material used in the present invention.

### [Transparent Member]

With respect to the transparent member for the present invention, those materials that have adaptability to substantially lowering the refractive index of the surface layer, including its vicinity, of the transparent member and transparency within the degree that does not influence on the light for the use are enough; material simply such as quartz, glass, and resin suffice for this. A transparent resin is preferable from the viewpoint of the easiness of changing or regulating the refractive index. It is preferable that the refractive index of the center portion of the transparent member is the refractive index of the member itself, because stability of the refractive index and the transparency are easily maintained.

### [Transparent Resin]

No limitation is imposed on the transparent resin to be used in the present invention as long as the resin has above-stated properties of a transparent member. As example of transparent resin used as the transparent member in the present invention, the following substances are preferable: the base resin (A) having thermal polymerizable functional group and the transparent resin (B) having at least thermal polymerizable compound. It becomes possible to produce the difference of refractive index by the exposure to, impregnation of, and inclusion of such a substance as suppresses the crosslinking in the substances of (A) and (B). Particularly, it is preferable that when the substance (A) includes carboxyl group in its molecule, and the substance (B) includes, in its molecule, epoxy group or similar group which thermally crosslinks with the carboxyl group in the substance (A), the crosslinking reaction between the carboxyl group and the epoxy group can be suppressed. Specifically, it is preferable in that the crosslinking reaction between the carboxyl group and the epoxy group can be suppressed by using the carboxyl group and the carboxylate as the above-stated cation. This suppression of the crosslinking reaction causes the surface layer that undergone exposure, impregnation, and inclusion to be the two-component system of crosslinked matter of the substance (A) and the substance (B), and also causes the center portion, which is not suppressed with respect to the crosslinking reaction, to be one-component system of a crosslinked matter of the substance (A) with the substance (B). The difference in the number of the component systems influences the material density. Generally, the density tends to decrease as the number of component systems increases. Therefore, the refractive index of the center portion becomes high and that of the surface layer becomes low. In addition, inclusion of ion such as cation generally causes the polarization to be large and the refractive index tends to become high (the refractive index has an approximate first order correlation with the material density and the polarization); however, it is possible to lower the refractive index when a resin composition in which the crosslinking density dominantly contributes to the refractive index is used, even if ion such as cation is included. As the above details the mechanism of producing the difference of refractive index in the transparent resin as an example of the present invention, the important point is that the difference of refractive index is produced and that the refractive index of the surface layer, including its vicinity, is lower than that of the center portion.

In addition, it is preferable that the transparent resin includes a photo polymerization compound (C) and a photo polymerization initiator (D). The inclusion of the substance (C) or the substance (D) allows the photo-curing by the light exposure at the Process C and thereby the resistance is given against solution and etchant. Further, undergoing the Process B of etching process eases forming into a desired shape. When the substance (C) is included but it does not form the crosslinking with any of substances (A) and (B), the number of component systems stated above in the surface layer, including its vicinity, becomes three-component system and the center portion becomes two-component system, which makes it possible to produce the difference of refractive index.

The following details the compounds (A) to (D).

The component (A) includes a base resin (polymer) having thermal polymerizable functional group, for example; and polymer that includes carboxyl group is listed as a preferable example. This polymer has no specific limitation.

However, polymers (1) to (6) listed below are examples of such polymer.

(1) Alkaline-soluble carboxyl group-containing polymer, which is obtained through copolymerizing compound having carboxyl group and ethylenically unsaturated group in its molecule and compound that includes ethylenically unsaturated group other than that.

(2) Alkaline-soluble carboxyl group-containing polymer, which is obtained partly introducing ethylenically unsaturated group in the side chain of copolymer of compound having carboxyl group and ethylenically unsaturated group in its molecule and compound that includes ethylenically unsaturated group other than that.

(3) Alkaline-soluble carboxyl group-containing polymer, which is obtained through the reaction of polybasic acid anhydride with hydroxyl group that is produced through reacting compound having carboxyl group and ethylenically unsaturated group in its molecule with copolymer of compound having epoxy group and ethylenically unsaturated group in its molecule and compound that includes ethylenically unsaturated group other than that.

(4) Alkaline-soluble carboxyl group-containing polymer, which is obtained through reaction of compound having hydroxyl group and ethylenically unsaturated group in its molecule with copolymer of acid anhydride having ethylenically unsaturated group and compound having ethylenically unsaturated group other than that.

(5) Alkaline-soluble carboxyl group-containing polymer, which is obtained reacting polybasic acid anhydride with polyaddition product of difunctional epoxy resin and dicarboxylic acid or difunctional phenolic compound.

(6) Alkaline-soluble carboxyl group-containing polymer, which is obtained reacting polybasic acid anhydride with hydroxyl group of polyaddition product of difunctional oxetane compound and dicarboxylic acid or difunctional phenolic compound.

Among these substances, alkaline-soluble carboxyl group-containing polymers listed in above items (1) to (4) are preferable from the viewpoint of transparency and solubility to alkaline solution in using alkaline solution as etchant. In addition, it is preferable that these polymers are (meth)acrylic polymer having (meth)acryloyl group. Here, (meth)acryloyl group means acryloyl group or methacryloyl group, or both. The (meth)acrylic polymer is a polymer obtained by polymerizing acrylic acid, acrylic acid ester, methacrylic acid, methacrylic acid ester, and their derivatives, treating each of them as monomer. The (meth)acrylic polymer may be homopolymer of above-stated monomer or may be copolymer of two or more of those monomers. In addition, within the degree that does not disturb the effect of the present invention, above-stated (meth)acrylic polymer may be copolymer that includes above-listed monomers and, where needed, monomer other than the above having ethylenically unsaturated group other than (meth)acryloyl group, or may be mixture of a plurality of (meth)acrylic polymers.

The weight-average molecular weight of the polymer of the component (A) being 1,000 to 3,000,000 is preferable. Where it is 1,000 or more, the strength of the hardened object is sufficient as a resin composition because the molecular weight is large. Where it is 3,000,000 or less, the solubility in etchant of alkaline solution and the compatibility with polymerizable compound (B) are acceptable.

From the above, the weight-average molecular weight of the component (A) being 3,000 to 2,000,000 is more preferable; and 5,000 to 1,000,000 is particularly preferable.

It is to be noted that the weight-average molecular weight in the present invention is a value converted into the standard polystyrene based on the measurement by the gel permeation chromatography (GPC).

When alkaline-soluble carboxyl group-containing polymer is used as the component (A), the acid number can be regulated so that the etching by alkaline solution is practicable in the process for forming the pattern by etching. For example, the acid number of 20 to 300 mgKOH/g is preferable when alkaline solution is to be used, which will be mentioned later.

When the acid number is 20 mgKOH/g or more, the etching is easy, and when 300 mgKOH/g or less, the etchant resistance does not degrade. From the above-stated viewpoint, the acid number of 30 to 250 mgKOH/g is more preferable and 40 to 200 mgKOH/g is particularly preferable.

It is to be noted that the term etchant resistance means such a nature that the portion which is to become the pattern being not removed in etching is not attacked by the etchant.

In addition, when alkaline quasi-aqueous etchant comprised of alkaline aqueous solution and one or more organic solution is to be used as the alkaline solution, the acid number of 10 to 260 mgKOH/g is preferable. When the acid number is 10 mgKOH/g or more, the development is easy, and when 260 mgKOH/g or less, the etchant resistance (the nature such that the portion which is to become the pattern being not removed in etching is not attacked by the etchant) does not degrade. From this viewpoint, the acid number of 20 to 250 mgKOH/g is more preferable and 30 to 200 mgKOH/g is particularly preferable.

The blending quantity of the component (A) is preferred to be 10 to 85 wt-% with respect to the total quantity of the components (A) and (B). When it is 10 wt-% or more, the strength and flexibility of the hardened transparent resin is enough; when 85 wt-% or less, the etchant resistance does not become insufficient because it easily cures by being captured in the component (B) at the time of exposure. From this viewpoint, the blending quantity of the component (A) of 20 to 80 wt-% is more preferable, and 25 to 75 wt-% is particularly preferable.

As thermal polymerizable compound for the component (B), any compound crosslinked by heat is enough. For example, a compound that has thermal polymerizable substituent group such as epoxy group is one of suitable materials.

In concrete terms, the suitable materials include the following: difunctional phenol glycidyl ether type epoxy resin, hydrogenated and difunctional phenol glycidyl ether type epoxy resin, polyfunctional phenol glycidyl ether type epoxy resin with a functional value of at least 3, difunctional aliphatic alcohol glycidyl ether type epoxy resin, difunctional alicyclic alcohol glycidyl ether type epoxy resin, polyfunctional aliphatic alcohol glycidyl ether type epoxy resin with a functional value of at least 3, difunctional aromatic glycidyl ester, difunctional alicyclic glycidyl ester, difunctional aromatic glycidyl amine, polyfunctional aromatic glycidyl amine with a functional value of at least 3, difunctional alicyclic epoxy resin, polyfunctional alicyclic epoxy resin with a functional value of at least 3, polyfunctional heterocyclic epoxy resin with a functional value of at least 3, and difunctional, or tri- or more-polyfunctional epoxy resin each containing silicon.

Above-listed compounds can be used singly or in combination of two or more among them; further, combined use with another polymerizable compound is also applicable.

As photo polymerizable compound for the component (C), compound crosslinked by light is enough. For example, compound that has photo polymerizable substituent group such as ethylenically unsaturated group is one of suitable materials.

In concrete terms, suitable materials include the following: (meth)acrylate, vinylidene halide, vinyl ether, vinyl ester, vinyl pyridine, vinyl amide, and arylated vinyl. Among these, (meth)acrylate and arylated vinyl are preferable from the viewpoint of the transparency. As (meth)acrylate, any of substances of monofunctional, difunctional, or polyfunctional composition can be used.

With respect to monofunctional (meth)acrylate, there is no particular limitation.

For example, suitable materials include the following: aliphatic (meth)acrylate such as various kinds of alkyl (meth)acrylate and various kinds of hydroxyalkyl (meth)acrylate, alicyclic (meth)acrylate, aromatic (meth)acrylate, heterocyclic (meth)acrylate, ethoxylated form of above substances, propoxylated form of above substances, ethoxylated and propoxylated form of above substances, and caprolactone-modified form of above substances.

With respect to difunctional (meth)acrylate, there is no particular limitation.

For example, suitable materials include the following: various kinds of aliphatic di(meth)acrylate such as ethylene glycol di(meth)acrylate, various kinds of alicyclic di(meth)acrylate such as cyclohexane dimethanol di(meth)acrylate, various kinds of aromatic (meth)acrylate such as bisphenol A di(meth)acrylate, various kinds of heterocyclic di(meth)acrylate such as isocyanulic acid di(meth)acrylate, ethoxylated form of above substances, propoxylated form of above substances, ethoxylated and propoxylated form of above substances, caprolactone-modified form of above substances, various kinds of aliphatic epoxy di(meth)acrylate such as neopentyl glycol type epoxy di(meth)acrylate, various kinds of alicyclic epoxy di(meth)acrylate such as hydrogenated bisphenol A type epoxy (meth)acrylate, and various kinds of aromatic epoxy di(meth)acrylate such as bisphenol A type epoxy di(meth)acrylate.

With respect to tri- or more-polyfunctional (meth)acrylate, there is no particular limitation.

For example, suitable materials include the following: various kinds of aliphatic (meth)acrylate such as trimethylolpropane tri(meth)acrylate, various kinds of heterocyclic (meth)acrylate such as isocyanulic acid tri(meth)acrylate, ethoxylated form of above substances, propoxylated form of above substances, ethoxylated and propoxylated form of above substances, caprolactone-modified form of above substances, and various kinds of aromatic epoxy (meth)acrylate such as phenol novolac type epoxy (meth)acrylate and clesol novolac type epoxy (meth)acrylate.

Each of the above-stated monofunctional (meth)acrylate, difunctional (meth)acrylate, and tri- or more-polyfunctional (meth)acrylate are usable singly or in combination with two or more among them. Further, combination with other (meth)acrylate having different number of functional groups can be applicable. Moreover, combination with other polymerizable compound is also usable.

As the photo polymerization initiator for the component (D), photo radical polymerization initiator or photo-cation polymerization initiator is used. To produce the difference of refractive index by inhibition of the thermal-curing, it is preferable to reduce the quantity of crosslinking to be formed by the photo-curing at the Process B, suppressing the raise of the refractive index resulted from the photo-curing. Thereby, the refractive index raising process for the transparent resin becomes to be a thermal-curing process. Thus, the transparent resin tends to lower the refractive index of the surface layer, including its vicinity thereof, as the influence on the refractive index by the crosslinking inhibition becomes sensitive. From this viewpoint, it is preferable to use the photo radical hardener rather than the photo-cation hardener. In concrete terms, suitable materials include the following: benzoin ketal, α-hydroxy ketone, glyoxylate, α-amino ketone, phosphine oxide, 2,4,5-triaryl imidazole dimer, benzophenone compound, quinone compound, benzoin compound, benzyl compound, acridine compound, N-phenyl glycine, and cumarin.

As the substituent groups in aryl group in the two triaryl-imidazole portions in the 2,4,5-triaryl imidazole dimer, identical and symmetrical compound may be used; or instead, unsymmetrical compound may be used.

Among these, α-hydroxy ketone, the glyoxylate, the oxim ester, and the phosphine oxide are preferable substance from the viewpoint of hardenability, transparency, and heat resistance.

Above-stated photo radical polymerization initiators can be used singly or in combination of two or more among them. Further, they can be used in combination with suitable sensitizing agent.

The components (B) and (C) used in the present invention are more preferred to be a mixed form compound that includes both photo polymerizable ethylenically unsaturated group and thermal polymerizing epoxy group in one molecule. In this case in the present invention, one single component can be regarded as a substance that includes both the component (B) and the component (C).

By inclusion of the composite form of mixture, the number of components after the thermal hardening stated above becomes two-component system in the surface layer, including its vicinity, and one-component system in the center portion, even when three components (A), (B), and (C) are included. Therefore, the difference of refractive index can be produced like the above-stated case. In addition, the rise in the refractive index by the thermal-curing of the transparent resin becomes larger than that by the photo-curing, because the quantity of crosslinking in the ethylenically unsaturated group is reduced. With this, the suppression of the thermal-curing eases producing the difference of refractive index.

As polymerizable compound of composite form, epoxy (meth)acrylate, which is obtained by reacting epoxy resin having two or more glycidyl groups in its molecule with (meth)acrylic acid compound, is an example. In this reaction, it is preferable to react (meth)acrylic acid compound of 0.1 to 0.9 equivalent weight with respect to epoxy group. The equivalent weight of 0.2 to 0.8 is more preferable and 0.4 to 0.6 is particularly preferable.

In concrete terms, suitable materials include the following: difunctional phenol glycidyl ether such as bisphenol A type epoxy (meth)acrylate, products originated from hydrogenated difunctional phenol glycidyl ether such as hydrogenated bisphenol A type epoxy (meth)acrylate, products originated from polyfunctional phenol glycidyl ether such as phenol novolac type epoxy (meth)acrylate, products originated from difunctional aliphatic alcohol glycidyl ether such as polyethylene glycol type epoxy (meth)acrylate, products originated from difunctional alicyclic alcohol glycidyl ether such as cyclohexane dimethanol type epoxy (meth)acrylate, products originated from polyfunctional aliphatic alcohol glycidyl ether such as trimethylolpropane type epoxy (meth)acrylate, products originated form difunctional aromatic glycidyl ester such as phthalic acid diglycidyl ester, and epoxy (meth)acrylate originated from difunctional alicyclic glycidyl ester such as tetrahydrophthalic acid diglycidyl ester.

Among these, substances preferred from the viewpoint of transparency, high refractive index, and heat resistance include the following: various types of epoxy (meth)acrylate such as bisphenol A type epoxy (meth)acrylate, bisphenol F type epoxy (meth)acrylate, bisphenol AF type epoxy (meth)acrylate, bisphenol AD type epoxy (meth)acrylate, biphenyl type epoxy (meth)acrylate, naphthalene type epoxy (meth)acrylate, fluorene type epoxy (meth)acrylate, phenol novolac type epoxy (meth)acrylate, and clesol novolac type epoxy (meth)acrylate.

### [Surface Layer and its Vicinity]

In the optical member by the present invention, those portions of the transparent member, which are the exposed portion, the impregnated portion, and the portion that includes the refractive index lowering agent, are the surface layer, including its vicinity, of the transparent member. By regulating the quantity of and time for exposure-impregnation or by determining the impregnation depth as desired, a layer that has substantially lowered refractive index can be formed to the desired depth.

The depth of the lowered refractive index portion (the thickness of the surface layer, including its vicinity) is imposed no particular limitation. It is preferable that the depth is to be 0.01 μm to 5 mm; 0.05 μm to 1 mm is more preferable for relatively eased depth control; 0.1 μm to 100 μm is further preferable because of more eased depth control. When using for the core pattern of the optical waveguide, depth of 0.1 to 30 μm is moreover preferable because lowering the optical loss becomes practicable.

Where the substantial refractive index is to be lowered using a solution, the refractive index of all the faces exposed to the solution lowers in the above-stated depth-wise direction. In the case of the core pattern of the optical waveguide, the low refractive index layer is formed at least on both sides and moreover on the upper face.

### [Solution]

As regards the solution to be used in the method for manufacturing an optical element by the present invention, it is enough that the solution is such a solution as causes the refractive index of the surface layer, including its vicinity, of the transparent member to become, after being exposed to the solution, substantially lower than that of the center portion of the transparent member. By lowering the refractive index of the surface layer, including its vicinity, of the transparent member using the solution, the positional variation of the degree of the lowering of the refractive index can be suppressed and the substantial refractive index of the transparent member can be lowered even if it has a complicated shape or an intricate configuration.

The usable kind of the solution includes water, organic solvent, alkaline solution, acidic solution, and similar liquids. As stated above for example, when the difference of the refractive index is to be produced in a manner in which a sparse portion, in terms of sparse or dense, is created in the exposed portion of the transparent member using a solution, the use of a solution, which dissolves at least one part of the exposed portion, can produce such index difference. In addition, when the difference of the refractive index is to be produced in a manner in which a high refractive index component, which is soluble in a solution, is included in the transparent member and the high refractive index soluble component is dissolved by solution, the use of a solution, which selectively specifically dissolves the high refractive index soluble component, can also produce such index difference. Further in addition, when the difference of the refractive index is to be produced in a manner in which the transparent member is exposed to a solution to be impregnated therein, wherein the solution includes a component having a low refractive index lower than the refractive index of the transparent member, and the low refractive index component is fixed in the transparent member; the use of a solution, which dissolves the low refractive index component and can be impregnated into the transparent member, can also produce such index difference. As will be mentioned later, when the difference of the refractive index is to be produced in a manner in which the exposure to a refractive index control agent to be impregnated therein is performed for impregnation, the use of a solution can produce such index difference, provided that the refractive index control agent is capable of changing the molecular geometry and the molecular network pattern and that the solution is capable of dissolving the refractive index control agent and impregnating the transparent resin with the agent. Among those solutions stated above, the use of a solution containing water as the main component avoids an adverse effect attributable to the dissolution or swelling of the transparent member. Therefore, it becomes possible to control the refractive index maintaining highly accurately the shape of the transparent member or the shape of the pattern formed on the transparent member.

As the suitable organic solvent, selecting an organic solvent that can achieve the above-stated purpose is enough.

Such organic solvent for example includes the following: aromatic hydrocarbon such as toluene, xylene, mesitylene, cumene, and p-cymene; chain ether such as diethyl ether, tert-butyl methyl ether, cyclopentyl methyl ether, and dibuthyl ether; cyclic ether such as tetrahydrofuran and 1,4-dioxane; alcohol such as methanol, ethanol, isopropanol, butanol, ethylene glycol, and propylene glycol; ketone such as acetone, methyl ethyl ketone, methyl isobutyl ketone, cyclohexanone, and 4-hydroxy-4-methyl-2-pentanone; ester such as methyl acetate, ethyl acetate, butyl acetate, methyl lactate, ethyl lactate, and γ-butyrolactone; carbonic acid ester such as ethylene carbonate and propylene carbonate; polyvalent alcohol alkyl ether such as ethylene glycol monomethyl ether, ethylene glycol monoethyl ether, ethylene glycol monobutyl ether, ethylene glycol dimethyl ether, ethylene glycol diethyl ether, propylene glycol monomethyl ether, propylene glycol monoethyl ether, propylene glycol dimethyl ether, propylene glycol diethyl ether, diethylene glycol monomethyl ether, diethylene glycol monoethyl ether, diethylene glycol monobutyl ether, diethylene glycol dimethyl ether, and diethylene glycol diethyl ether; polyvalent alcohol alkyl ether acetate such as ethylene glycol monomethyl ether acetate, ethylene glycol monoethyl ether acetate, ethylene glycol monobutyl ether acetate, propylene glycol monomethyl ether acetate, propylene glycol monoethyl ether acetate, diethylene glycol monomethyl ether acetate, and diethylene glycol monomethyl ether acetate; and amide such as N,N-dimethylformamide, N,N-dimethylacetamide, and N-methylpyrrolidone.

These organic solvents can be used singly or in combination of two or more among them.

As the suitable alkaline solution, selecting an alkaline solution that can achieve the above-stated purpose is enough.

The solute of such alkaline solution for example includes the following bases: alkali metal hydroxide such as lithium hydroxide, sodium hydroxide, and potassium hydroxide; alkali metal carbonate such as lithium carbonate, sodium carbonate, and potassium carbonate; alkali metal bicarbonate such as lithium hydrogen carbonate, sodium hydrogen carbonate, and potassium hydrogen carbonate; alkali metal phosphate such as potassium phosphate and sodium phosphate; alkali metal pyrophosphate such as sodium pyrophosphate and potassium pyrophosphate; sodium salt such as sodium tetraborate and sodium metasilicate; ammonium salt such as ammonium carbonate and ammonium hydrogen carbonate; and organic base such as tetramethyl ammonium hydroxide, triethanolamine, ethylenediamine, diethylenetriamine, 2-amino-2-hydroxy methyl-1,3-propanediol, and 1,3-diamino propanol-2-morpholine.

These bases can be used singly or in combination of two or more among them.

As the suitable acidic solution, selecting an acidic solution that can achieve the above-stated purpose is enough.

The solute of such acidic solution for example includes the following acids: hydrochloric acid, hydrobromic acid, hydriodic acid, hypochlorous acid, chlorous acid, chloric acid, perchloric acid, hypobromous acid, bromous acid, bromic acid, perbromic acid, hypoiodous acid, iodous acid, iodic acid, periodic acid, sulfric acid, fluorosulfonic acid, nitric acid, phosphoric acid, hexafluoroantimonic acid, tetrafluorophosphonic acid, chromic acid, boric acid, methansulfonic acid, ethane sulfonic acid, benzenesulfonic acid, trifluoromethane sulfonic acid, formic acid, acetic acid, citric acid, gluconic acid, lactic acid, oxialic acid, tartaric acid, ascorbic acid, Meldrum's acid, and similar acids. The solution may further include two or more among these in a form of a mixed-solution.

Where necessary, above-listed water, organic solvent, alkaline solution, and acidic solution may include a refractive index lowering agent that can lower the refractive index of the transparent resin.

### [Refractive Index Regulating Agent]

With respect to the refractive index regulating agent capable of lowering the substantial refractive index of the surface layer, including its vicinity, of the transparent member in the present invention, there is no particular limitation; any material is usable as long as the material can lower the refractive index substantially. For example, a material that has a refractive index lower than that of the transparent resin and fixes on the transparent resin through exposure, impregnation, or inclusion is usable. In addition as will be mentioned later, the transparent member is a transparent resin, and another material having a function of suppressing crosslinking reaction may be used as a refractive index regulating agent to lower the refractive index through the processes of exposure, impregnation, and inclusion of the material to the surface of the transparent resin. Thus, the present invention has a notable feature in that the invention exerts its function that substantially lowers the refractive index of the surface layer of the transparent member by including the refractive index regulating agent in the surface layer thereof. In the case of the resin composition stated above, it is preferable that the refractive index regulating agent is cation, because the substantial refractive index can be efficiently lowered. Positive monovalent metal ion is more preferable, because the ion crosslinking is suppressed, on the other hand, the use of ionic bond or similar bonding makes fixing easy. Potassium ion or sodium ion is moreover preferable. Therefore, the above-stated alkaline solution can be used as the refractive index regulating agent.

In the present invention, even when monofunctional compound (monomer) or compound (monomer), which includes polymerizable functional group whose curing reaction is slower than that of the center portion of the transparent member, is used as the refractive index control agent instead of monovalent metal ion, the effect of suppressing the crosslinking reaction is obtained and the refractive index of the surface layer, including its vicinity, of the transparent member can be substantially lowered.

### [Optical Waveguide]

The optical waveguide by the present invention is comprised of a lower clad layer, a core pattern, and an upper clad layer. The optical waveguide has a low refractive index portion on two or more sides of four sides of the circumference of the rectangular shape of the cross-section of its core pattern, wherein the refractive index of the low refractive index portion is lower than that of the center of the core pattern. In this optical waveguide, the lower clad layer or the upper clad layer, or both, each of which has a more-lower refractive index, are provided outside the low refractive index portion. Above-stated two sides are preferred to be both side walls of the core pattern; and it is more preferable that they are three or more sides.

Further, it is preferable that the difference of refractive index between the low refractive index portion and the lower clad layer or the upper clad layer, or both, is to be larger than the difference of refractive index (the calculation by the formula shown previously) between the core pattern center and the low refractive index portion around the core pattern. Thereby, the leakage component in the light from the low refractive index portion can be effectively confined within the core pattern.

The difference of refractive index between the core pattern center and the low refractive index portion around the core pattern is preferred to be 0.01 to 2.0% (multiplied by 100 on the value of expression). From the viewpoint of easiness of the refractive index control of material, 0.02 to 2.0% is more preferable and 0.03 to 1.0% is moreover preferable.

The difference of refractive index between the low refractive index portion and the lower clad layer or the upper clad layer, or both, is preferred to be 0.1 to 6.0% within the extent where such difference is larger than that of between the core pattern center and the low refractive index portion around the core pattern. From the viewpoint of confining the light and easiness of the refractive index control of material, 1.0 to 5.0% is more preferable and 2.0 to 5.0% is moreover preferable.

In addition, it is preferable that the refractive index of the center portion 4 of the core pattern 3 is the refractive index of the cured resin for forming the core pattern itself, because such configuration makes the maintaining of the stability of the refractive index and the penetrability easy.

Further, the optical waveguide by the present invention can adapt to incorporating an optical path changing mirror that changes the optical path direction about 90 degrees on its optical axis of the core pattern; it may be used in an opt-electrical composite circuit board combined with electrical wiring of various kinds; and it may be also used as an optical fiber cable coupled with optical fibers through connecting device such as connectors.

### [Lower Clad Layer and Upper Clad Layer]

The lower clad layer and the upper clad layer used in the optical wave guide by the present invention is arranged so as to cover at least the bottom face and the top face of the core pattern. When both side walls are also covered, the configuration is more preferable.

No particular limitation is imposed on the method for forming the lower clad layer or the upper clad layer. However, applying a varnish-like resin layer for forming the clad layer or laminating a film-like resin layer for forming the clad layer by laminating or pressing is a method for forming the lower clad layer for example. From the viewpoint that the curing is performed after applying or laminating, use of thermal-curing resin, photo-curing resin, combined photo and thermal-curing resin, and other similar resin are preferable.

No particular limitation is imposed on the thickness of the lower clad layer. However, a thickness of 5 μm or more is preferable from the viewpoint of light-confining property, but 200 μm or less is enough from the viewpoint of formability of a thick resin layer. From the viewpoint of the thickness control, the preferable thickness is 10 μm or more and 150 μm or less; the thickness of 10 μm or more and 100 μm or less is more preferable from the viewpoint of lowering the profile height.

In addition, the lower clad layer may have a single layer or a multiple layer configuration and may not be necessarily of the same material as the upper clad layer.

No particular limitation is imposed on the thickness of the upper clad layer. However, a thickness of 5 μm or more from the top face of the core pattern is preferable from the viewpoint of light-confining property, but the thickness of the resin layer for forming the clad layer used is preferred to be 200 μm or less from the viewpoint of formability of a thick resin layer. From the viewpoint of the thickness control, the preferable thickness is 10 μm or more and 150 μm or less; the thickness of 10 μm or more and 100 μm or less is more preferable from the viewpoint of lowering the profile height.

### [Core Pattern]

The core pattern 3 used in the optical waveguide by the present invention has a high refractive index higher than that of both the lower clad layer 2 and the upper clad layer 6 and is the major part in which light propagates.

From the viewpoint stated above, it is enough that a transparency is provided having a property that practically does not affect the propagation of used light.

With respect to the type of the core pattern material, there is no particular limitation; any material such as quartz, glass, resin, or other similar material is usable as long as above-stated conditions are satisfied. In forming the pattern, use of transparent resin is preferred from the viewpoint of adhesion properties and forming-adaptability. The method for forming the core pattern includes photo lithography, which performs exposure and etching after applying a varnish-like resin for forming the core pattern on the object (the lower clad layer), or after laminating a film-like resin for forming the core pattern by laminating or pressing; and anisotropic etching (dry etching). The method further includes application of film-like or varnish-like resin for forming the core pattern selectively on the desired place to form the core pattern. The lithography is the preferable method because the method is cable of positioning with high accuracy. From this point of view, the resin for forming the core pattern is preferred to be an etchable resin layer and more preferably a photosensitive resin layer.

It is important that, within the extent stated above, the material of the core pattern is such a material as is capable of producing a low refractive index lower than that of the center of the core pattern in the area of the circumference of two or more sides of the core pattern.

As for the shape of cross-section of the core pattern, any shape is acceptable when such shape allows light to propagate. The acceptable shape includes rectangles (tetragons), polygons, circles, and ellipses. In the case of polygonal shape other than rectangle, it is preferable that the two or more circumference of that shape are capable of forming the low refractive index portion, and it is also preferable that as large as possible number of sides have same properties. When the shape is a circle or a ellipse, it is preferable that the half or more portion of the circumference of such shape is the low refractive index portion; it is more preferable that the entire circumference is the low refractive index area. In forming by the above-stated photo lithography, rectangular shape is preferable because such shape is easy to process.

No particular limitation is imposed on the thickness of the core pattern. However, the thickness of the core pattern of 10 μm or more has an advantage in that the positional alignment tolerance can be enlarged in the coupling with light emitting-receiving elements after the fabrication of optical devices, or with optical fibers or optical devices. When the thickness is 160 μm or less, there is another advantage in that the coupling efficiency is improved in the coupling with light emitting-receiving elements after the fabrication of optical devices, or with optical fibers or optical devices; further in that the phase difference of the propagating light caused by the total reflection is reduced; and consequently in that the light propagation loss is lowered. From these viewpoints, the thickness of the core pattern is preferred to be 10 to 160 μm; more preferably 20 to 100 μm, moreover preferably within the range of 30 to 80 μm.

### [Etchant]

No particular limitation is imposed on the etchant. However, usable etchant includes organic solvent etchant such as quasi-aqueous etchant comprising organic solvent, or organic solvent and water; and alkaline etchant such as alkaline quasi-aqueous solution etchant comprising alkaline aqueous solution, or alkaline solution and one or more organic solvent. The etching temperature is regulated in accordance with the etching properties of the resin layer for forming the core pattern.

No particular limitation is imposed on the organic solvent; above-listed organic solvents are usable for example.

Those organic solvents may be used singly or in combination with two or more among them. In the organic solvent, surface active agent, antifoaming agent, refractive index lowering agent, or similar agent may by mixed.

No particular limitation is imposed on the base of alkaline aqueous solution; above-listed bases are usable for example.

Those bases may be used singly or in combination with two or more among them.

The pH value of the alkaline solution used in etching is preferred to be 9 to 14. In the alkaline aqueous solution, surface active agent, antifoaming agent, refractive index lowering agent, or similar agent may be mixed.

With respect to the alkaline quasi-aqueous etchant, there is no particular limitation; any material is usable as long as the material comprises alkaline aqueous solution and one or more of the above-listed organic solvents. The pH value of the alkaline quasi-aqueous etchant is preferable to be as lower as possible within the extent that etching can adequately complete. In this, the pH value of 8 to 13 is preferable and 9 to 12 is more preferable.

Usually, the concentration of the organic solvent is preferred to be 2 to 90 wt-%. In the alkaline quasi-aqueous etchant, a small amount of surface active agent and antifoaming agent may be mixed; refractive index lowering agent or similar agent may also be mixed.

As the post-processing of the etching, cleaning treatment may be performed where necessary using above-stated organic solvent, quasi-aqueous cleaning fluid comprising the organic solvent and water, water, or acidic solution. By this cleaning treatment, the refractive index lowering agent that is excessively impregnated into the transparent resin may be removed to a certain degree.

In the case of the above-stated transparent resin, cleaning the transparent resin with acidic solution can remove excessive potassium ion and sodium ion and, further, potassium ion and sodium ion on the outermost portion of the surface layer can be removed. (When carboxylate salt turns into carboxylic acid by acidic solution, the hydrophoby then increases, which prevents substitution of potassium and sodium from spreading to the inside.) This state is preferable, because it becomes possible to leave potassium ion or sodium ion in the surface layer, including its vicinity, of the transparent resin.

The following details each of the processes to be used in the method for manufacturing an optical member by the present invention.

### [Process A and Process A′]

The Process A used in the method for manufacturing an optical member by the present invention is as follows. In the process, a transparent member is exposed to a solution to make the refractive index of the exposed portion of the transparent member substantially lower than that of the center portion of the transparent member, where the center is a non-exposed portion. No particular limitation is imposed on the method for exposing; the usable method includes spraying method, dipping method, paddling method, spinning method, blushing method, and scrapping method, or other similar method. Where needed, these methods may be used in combination among them.

Thereby, the exposed portion having different refractive index can be formed approximately uniformly. In addition, the using of solution has an advantage in that such use is capable of substantially lowering the refractive index of the exposed portion of the transparent member even if the portion has a complicated shape or an intricate configuration. That method is also capable of substantial lowering the refractive index of the surface layer, including its vicinity, of the side of the core pattern or similar portions of the optical waveguide.

The Process A′ as another method used in the method for manufacturing an optical member by the present invention is as follows. In the process, a refractive index regulating agent that substantially lowers the refractive index of the transparent member is included in the surface layer of the transparent member, and thereby the refractive index of the surface layer that includes the refractive index regulating agent is substantially lowered lower than that of the center portion of the transparent member. The method for adding the refractive index regulating agent includes making the refractive index control agent included in the surface layer, including its vicinity, of the transparent member in advance, embedding the refractive index regulating agent in the transparent member by known methods (spattering for example). The method further includes, like the Process A stated above, exposing the transparent member to the liquefied refractive index regulating agent or to the refractive index regulating agent dissolved in a solution to include the refractive index regulating agent in the surface layer, including its vicinity, of the transparent member.

If the method to be used is to perform the inclusion in advance, such method is preferable from the viewpoint of regulating the refractive index at desired point. However, from the viewpoint of lowering the refractive index of the surface layer of the transparent member with a uniform condition, it is a preferable method to expose the transparent member to the refractive index regulating agent that is liquefied or dissolved in a solution.

### [Process B]

The Process B used in the method for manufacturing an optical member by the present invention is as follows. The Process B is a process that forms the pattern by etching provided that the transparent member is an etchable member by etchant. Since the Process B performs the patterning by etching, the process is preferable in that a transparent member of desired shape can be easily obtained and in that the lump-processing becomes practicable. With respect to the etching method, there is no particular limitation; any method is usable as long as the method performs processing in which etchable portion and not-etchable portion are selectively formed in advance and then the etchable portion is removed by the etchant. For example, a method that performs forming an etching resist having a pattern on the transparent member and then removing the portion having no etching resist by etching, or forming uncured portion and cured portion (includes photo-curing) on the transparent member using heat or light and after that removing the uncured portion by the etchant, is a usable method. Further, no particular limitation is imposed on the method for immersing in the etchant; the usable method includes spraying method, dipping method, paddling method, spinning method, blushing method, and scrapping method, or other similar methods. Where needed, these methods may be used in combination among them.

It is useful to perform the Process A, or the Process A′, simultaneously with or after the Process B; thereby, the refractive index of the surface layer of the side wall of the patterned transparent member can be substantially lowered. When the Process A, or the Process A′, is to be performed after the Process B, a consecutive performance of the exposing to the solution and the etching can manufacture the optical member of the present invention efficiently. It is however more preferable to perform the Process A, or the Process A′, simultaneously with the Process B, because the number of the process steps is reduced thereby contributing to the improvement of the work efficiency. From this point of view, when the Process A, or the Process A′, is to be performed simultaneously with the Process B, it is preferable that the etchant is the same as the above-stated solution that can substantially lower the refractive index, or a mixture of such solutions.

### [Process C]

The Process C used in the method for manufacturing an optical member by the present invention is as follows. The Process C performs irradiation of activation light ray before the Process A or the Process A′, or the Process B, or both, to achieve the photo-curing when the transparent member is a light-sensitive transparent resin. Thereby, the solution resistance is improved because the photo-curing proceeds with the activation light ray, even when exposed to solution. Further, the etching resistance against the etchant in the patterning by etching improves. Using same liquid for the solution and the etchant (mixed liquid of them is also usable) improves the workability, because the Process A and the Process B can be performed simultaneously.

The activation light ray to be used for photo-curing of the light-sensitive transparent resin is sufficient as long as the light ray has a wavelength that can cause the photo-curing of the light-sensitive transparent resin. Ultraviolet light, visible light, infrared, etc. are included as suitable lights. Among these, ultraviolet light is preferable because the photo-curing with that light is efficient. No particular limitation is imposed on the amount of irradiation of the activation light ray. However, the amount of irradiation of 10 to 10000 mJ/cm² is preferable, 30 to 5000 mJ/cm² is more preferable, and 40 to 4000 mJ/cm² is moreover preferable. In addition, the activation light ray may be irradiated furthermore after the patterning when patterning is performed by etching. There is no particular requirement for the amount of this further-irradiation. However, the amount of irradiation of 100 to 10000 mJ/cm² is preferable, 300 to 5000 mJ/cm² is more preferable, and 400 to 4000 mJ/cm² is moreover preferable. Exposure after the patterning can improve the adhesion of the pattern.

### [Process D]

The Process D used in another method for manufacturing an optical member by the present invention is as follows. In the case where the transparent member is transparent resin and the transparent member is thermally cured, the Process D comprises the steps of curing the transparent resin thermally, and making the refractive index of the surface layer, including its vicinity, of the transparent resin after the thermal-curing substantially lower than that of the center portion of the transparent resin after the thermal-curing.

It is preferable to provide a Process D′ after the Process A or the Process A′, wherein the Process D′ is a process of the thermal-curing of the transparent resin. Applying the thermal-curing process cures the unreacted photo-curing component and the thermal-curing component; and further, the process can fix the refractive index regulating agent used in the exposure and impregnation to a certain degree.

No particular limitation is imposed on the temperature for thermal-curing in the Process D or the Process D′. However, the temperature of 40 to 280° C. eases maintaining the transparency of the resin; 80 to 200° C. is more preferable and 100 to 190° C. is moreover preferable. Heating time of 5 minutes to 5 hours is possible to cause thermal-curing; 20 minutes to 3 hours is preferable and 30 minutes to 2 hours is moreover preferable.

No particular limitation is imposed on the measuring method of the refractive index on the transparent member of the present invention. However, the following method is preferred. The samples for measuring the refractive index can be prepared by one of the methods (1) to (3) listed below.

(1) Preparing a transparent member sample that has not undergone the refractive index lowering treatment (exposure to and impregnation with solution, and inclusion of refractive index lowering agent), and preparing a transparent member sample that has undergone the refractive index lowering process; and measuring the refractive indexes of each of the prepared samples.

(2) Covering partially the surface of a transparent member, applying the refractive index lowering treatment thereon; and measuring the refractive index of each of the not-covered portion and the cover-removed portion of the transparent member.

(3) Performing the refractive index lowering treatment on a transparent member, breaking the treated member into pieces, and measuring the refractive index of each of the broken-pieces of the surface layer, including its vicinity, and the broken-pieces of the center portion of the transparent member.

Any known measuring methods are usable for measuring the refractive index. Minimum deviation method, the critical angle method, the interferometry (low coherence interferometry, phase shift method, etc.) are usable.

### EMBODIMENTS

The following details embodiments of the present invention. However, the mode of implementation of the invention is not limited to those embodiments.

### Embodiment 1

### Preparation of Resin Film for Forming Transparent Member

[Preparation of Base Polymer: (Meth)acrylic Polymer (P-1) for forming Transparent Member]

42 parts by weight of propylene glycol monomethyl ether acetate and 21 parts by weight of methyl lactate were weighed and put in a flask equipped with a stirrer, a cooling tube, a gas-introduction tube, a dripping funnel, and a thermometer; then they were stirred while introducing nitrogen gas. The temperature of the liquid was risen to 65° C. and then a mix was dripped over a period of three hours.

The mix dripped was a blend of 14.5 parts by weight of N-cyclohexyl maleimide, 20 parts by weight of benzyl acrylate, 1.5 parts by weight of o-phenylphenol, 39 parts by weight of acrylate, 14 parts by weight of 2-hydroxyethyl methacrylate, 12.5 parts by weight of methacrylic acid, 4 parts by weight of 2,2′-azobis(2,4-dimethyl valeronitrile), 37 parts by weight of propylene glycol monoethyl ether acetate, and 21 parts by weight of methyl lactate.

After the three hours of dripping, it was stirred for three hours at 65° C. The stirring was further performed for another one hour at 95° C.; then (meth)acrylate polymer (P-1) solution (solid content 45 wt-%) was obtained.

### [Measuring Acid Number]

The measurement of the acid number of the P-1 was 80 mgKOH/g. The acid number was calculated from the amount of 0.1 mol/L of potassium hydroxide aqueous solution consumed to neutralize the P-1 solution. In this measuring, phenolphthalein was added as an indicator to detect the neutralization point; and the point where the indicator discolored from colorless to pink was defined as the neutralization point.

[Measuring Weight-average Molecular Weight]

The measured weight-average molecular weight (converted into standard polystyrene) of the P-1 was 3.2×10⁴. The measuring instrument used was GPC (SD-8022, DP-8020, and RI-8020, by Tosoh Corp.) The columns used in this measuring were “Gelpack GL-A150-S” and “Gelpack GL-A160-S”, by Hitachi Chemical, Co., Ltd. As the eluent, tetrahydrofuran was used, of which sample concentration was 0.5 mg/mL, and the elution rate was 1 ml/min; then the measuring was carried out. The result was 32,000.

### [Preparation of Resin Varnish for Forming Transparent Member]

The following substances were weighed and put in a wide-mouthed poly-bottle:

(A) 60 parts by weight of the P-1 solution (solid content 45 wt-%) as alkaline-soluble (meth)acrylic polymer that includes maleimide skeleton in its main chain;

(B) 40 parts by weight of bisphenol A type epoxy acrylate (EA-1010N, by Shin-Nakamura Chemical Co., Ltd.) (epoxy equivalent weight 518 g/eq) as polymerizable compound; and

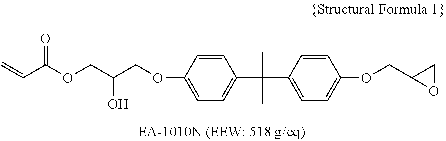 [SMILES: C=CC(=O)OCC(O)COc1ccc(C(C)(C)c2ccc(OCC3CO3)cc2)cc1]

(D) As the polymerization initiator, one part by weight of 1-[4-(2-hydroxyethoxy)-phenyl]-2-hydroxy-2-methyl-1-propane-1-one (Irgacure 2959, by Ciba Specialty Chemicals, Inc.) and one part by weight of bis(2,4,6-trimetylbenzoyl) phenyl phosphine oxide (Irgacure 819, by Ciba Specialty Chemicals, Inc.)

They were then stirred using a stirrer at a rate of 400 rpm for six hours under the temperature of 25° C. to prepare a resin varnish for forming the core part. The varnish was then filtered under pressure using Polyflon filter (PF020, by Advantec Toyo Kaisha, Ltd.) having a pore size of 2 μm and Membrane filter (J050AS, by Advantec Toyo Kaisha, Ltd.) having a pore size of 0.5 μm, under the conditions of temperature of 25° C. and pressure of 0.4 MPa. Subsequently, the vacuum degassing was performed for 15 minutes under a reduced pressure of 50 mmHg using a vacuum pump and a bell jar to obtain a resin varnish for forming the transparent member.

[Manufacturing Resin Film for Forming Transparent Member]

The resin varnish for forming the transparent member thus obtained was applied on an un-treated face on PET film (A1517, thickness 16 μm, by Toyobo Co., Ltd.) using a coater (Multi Coater TM-MC, by Hirano Tecseed Co., Ltd.), and then the applied varnish was dried for 20 minutes at 100° C. After the drying, a release coating PET film (A31, thickness 25 μm, by Teijin DuPont Films Japan Ltd.) was adhered as a protection film to obtain the resin film for forming the transparent member. The thickness of the resin layer is controllable as desired by manipulating the gap on the coater. In this embodiment, the gap was adjusted so that the film thickness was 50 μm.

### [Measuring Refractive Index]

The resin film for forming the transparent member thus obtained was cut into 100 mm×100 mm size. The ultraviolet light (wavelength 365 nm) was irradiated from a supporting film side using the ultraviolet light exposure equipment (EXM-1172, by Orc Manufacturing Co., Ltd.) with the irradiation rate of 3500 mJ/cm². After the irradiation, the supporting film was removed. Then, the member was immersed in 1.0 wt-% of potassium carbonate aqueous solution (liquid temperature 30° C.) for three minutes and washed with pure water. Subsequently, heating was performed for one hour at 160° C. to dry and cure; then the protection film was removed to obtain the optical member.

The refractive index at the wave length 830 nm of the supporting film side (the side immersed in the potassium carbonate aqueous solution) of this optical member was measured using a prism-coupled refractometer (Model 2020, by Metricon Co.) The measured refractive index was 1.556. The refractive index was further measured at arbitrary chosen 20 places (the separations between each adjacent places were about one centimeter). The measured refractive indices showed no position-dependent variations. The IR measuring was conducted about the surface; carboxylic anion peak was observed. The EDX measuring was also conducted; potassium was detected. The refractive index of the protection film side (the side not immersed in the potassium carbonate aqueous solution) was 1.558. The refractive index was further measured at arbitrary chosen 20 places (the separations between each adjacent places were about one centimeter). The measured refractive indices showed no position-dependent variations. The IR measuring was conducted about the surface; carboxylic anion peak was not observed. The EDX measuring was also conducted; potassium was not detected. The depth-wise EDX analysis was conducted; potassium was detected to the depth 5 μm from the surface. Further, a heating was given for two hours at 160° C. and then the refractive index was measured at the other arbitrary chosen places in the same manner as the above. The refractive index was 1.556 at the supporting film side and 1.558 at the protection film side, which meant that no change had occurred.

Another resin film for forming the transparent member was prepared through the processes similar to those stated above, except that the thermal-curing was omitted, and the protection film was removed therefrom to provide the optical member. The refractive index of the supporting film side (the side immersed in the potassium carbonate aqueous solution) was measured at the wave length 830 nm with the same method as stated above. The refractive index was 1.552 at the supporting film side and 1.549 at the protection film side.

### Embodiment 2

Another optical member was manufactured in the same manner employed in the embodiment 1, except that the 1.0 wt-% of sodium carbonate aqueous solution was used in place of 1.0 wt-% of potassium carbonate aqueous solution in the embodiment 1.

The refractive index at the wavelength 830 nm of the supporting film side (the side immersed in the sodium carbonate aqueous solution) of this optical member was measured using a prism-coupled refractometer (Model 2020, by Metricon Co.) The measured refractive index was 1.556. The refractive index was further measured at arbitrary chosen 20 places (the separations between each adjacent places were about one centimeter). The measured refractive indices showed no position-dependent variations. The IR measuring was conducted about the surface; carboxylic anion peak was observed. The EDX measuring was also conducted; sodium was detected. The refraction index of the protection film side (the side not immersed in the sodium carbonate aqueous solution) was 1.558. The refractive index was further measured at arbitrary chosen 20 places (the separations between each adjacent places were about one centimeter). The measured refractive indices showed no position-dependent variations. The IR measuring was conducted about the surface; carboxylic anion peak was not observed. The EDX measuring was also conducted; sodium was not detected. The depth-wise EDX analysis was conducted; sodium was detected to the depth 5 μm from the surface. Further, a heating was given for two hours at 160° C. and then the refractive index was measured at the other arbitrary chosen places in the same manner as the above. The refractive index was 1.556 at the supporting film side and 1.558 at the protection film side, which meant that no change had occurred.

Another resin film for forming the transparent member was prepared through the processes similar to those stated above, except that the thermal-curing was omitted, and the protection film was removed therefrom to provide the optical member. The refractive index of the supporting film side (the side immersed in the potassium carbonate aqueous solution) was measured at the wavelength 830 nm with the same method as stated above. The refractive index was 1.552 at the supporting film side and 1.549 at the protection film side.

### Embodiment 3

### Preparation of Resin Film for Forming Clad Layer

### [Preparation of Base Polymer (A): (Meth)Acrylate Polymer (A-1)]

46 parts by weight of propylene glycol monomethyl ether acetate and 23 parts by weight of methyl lactate were weighed and put in a flask equipped with a stirrer, a cooling tube, a gas-introduction tube, a dripping funnel, and a thermometer; then they were stirred while introducing nitrogen gas. The temperature of the liquid was risen to 65° C. and then a mix was dripped over a period of three hours.

The mix dripped was a blend of 47 parts by weight of methyl methacrylate, 33 parts by weight of butyl acrylate, 16 parts by weight of 2-hydroxyethyl methacrylate, 14 parts by weight of methacrylic acid, 3 parts by weight of 2,2′-azobis(2,4-dimethyl valeronitrile), 46 parts by weight of propylene glycol monomethyl ether acetate, and 23 parts by weight of methyl lactate.

After the three hours of dripping, it was stirred for three hours at 65° C. The stirring was further performed for another one hour at 95° C.; then (meth)acrylate polymer (A-1) solution (solid content 45 wt-%) was obtained.

### [Measuring Weight-average Molecular Weight]

The measured weight-average molecular weight (converted into standard polystyrene) of the (A-1) was 3.9×10⁴. The measuring instrument used was GPC (SD-8022, DP-8020, and RI-8020, by Tosoh Corp.) The columns used in this measuring were “Gelpack GL-A150-S” and “Gelpack GL-A160-S”, by Hitachi Chemical, Co., Ltd.

### [Measuring Acid Number]

The measurement of the acid number of the (A-1) was 79 mgKOH/g. The acid number was calculated from the amount of 0.1 mol/L of potassium hydroxide aqueous solution consumed to neutralize the A-1 solution. In this measuring, phenolphthalein was added as an indicator to detect the neutralization point; and the point where the indicator discolored from colorless to pink was defined as the neutralization point.

### [Preparation of Resin Varnish for Forming Clad Layer]

The following substances were mixed while stirring:

(A) 84 parts by weight (solid content 38 wt-%) of above-stated (A-1) solution (solid content 45 parts by weight) as the base polymer;

(B) 33 parts by weight of urethane (meth)acrylate (U-200AX, by Shin-Nakamura Chemical Co., Ltd.) having polyester skeleton and 15 parts by weight of urethane (meth)acrylate (UA-4200, by Shin-Nakamura Chemical Co., Ltd.) having polypropylene glycol skeleton both as the photo hardening component;

(C) 20 parts by weight (solid content 15 parts by weight) of polyfunctional blocked isocyanate solution (solid content 75 wt-%) (Sumidure BL3175, by Sumika Bayer Urethane Co.) as the thermal-curing component, in which isocyanurate type trimer of hexamethylene diisocyanate is protected by methyl ethyl ketone oxime; and

(D) One part by weight of 1-[4-(2-hydroxyethoxy)-phenyl]-2-hydroxy-2-methyl-1-propane-1-one (Irgacure 2959, by Ciba Japan, Co.) and one part by weight of bis(2,4,6-trimetylbenzoyl) phenyl phosphine oxide (Irgacure 819, by Ciba Japan, Co.) both as the photo polymerization initiator, and 23 parts by weight of propylene glycol monomethyl ether acetate, as an organic solvent for dilution.

The mix was then filtered under pressure using Polyflon filter (PF020, by Advantec Toyo Kaisha, Ltd.) having a pore size of 2 μm. After the filtration, the vacuum degassing was performed to obtain a resin varnish for forming the clad layer.

The resin compound for forming the clad layer thus obtained was applied on an un-treated face of PET film, the carrier film, (COSMOSHINE A4100, thickness 50 μm, by Toyobo Co., Ltd.) using a coater (Multi Coater TM-MC, by Hirano Tecseed Co., Ltd.), and then the applied resin compound was dried for 20 minutes at 100° C. After the drying, a release coating PET film (Purex A31, thickness 25 μm, by Teijin DuPont Films Japan Ltd.) was adhered as a cover film to obtain the resin film for forming the clad layer. The thickness of the resin layer is controllable as desired by manipulating the gap on the coater. The thicknesses of the lower clad layer 2 and the upper clad layer 6 used in this embodiment will be described in embodiments. The film thicknesses of the lower clad layer 2 and the upper clad layer 6 after the hardening were same as those after coating application.

### [Measuring Refractive Index]

A refractive index measurement sample was prepared by laminating the resin film for forming the clad on a silicon substrate (size: 60×20 mm, thickness 0.6 mm) followed by a curing treatment. The refractive index of the sample at the wavelength 830 nm was measured using a prism-coupled refractometer (Commercial name: Model 2020, by Metricon Co.) The measuring was conducted under the predetermined constant temperature between 15 and 30° C. (25° C. for example). The refractive index of the resin layer after the hardening was 1.496.

### <Manufacturing Example of Optical Waveguide Shown in FIG. 1>

### [Forming Lower Clad Layer 2]

Polyimide film (polyimide: Kapton EN, thickness: 25 μm) having the size of 100 mm×100 mm was used as the substrate 1. On one side thereof, lamination was performed, using a vacuum-pressurizing laminator (MLVP-500, by Meiki Co., Ltd.), after removal of the protection film on the resin film of a 15 μm-thickness thus obtained for forming the clad layer. The lamination was carried out by a 30 seconds of hot-pressing at a pressure of 0.4 MPa and a temperature of 90° C., after the evacuation below 500 Pa. Subsequently, ultraviolet light (wavelength 365 nm) was irradiated at the irradiation rate of 3000 mJ/cm² from a supporting film side of the resin film A using the ultraviolet light exposure equipment (EXM-1172, by Orc Manufacturing Co., Ltd.) After the irradiation, the supporting film was removed and then the lower clad layer 2 was formed by drying and curing for one hour at 170° C.

### [Forming Core Pattern 3]

On the lower clad layer 2 thus obtained, the resin film of 50 μm-thick obtained as stated above for forming the transparent member was laminated as the resin film for forming the core pattern, using a roll laminator (HLM-1500, by Hitachi Chemical Techno Plant Co.), after removal of the protection film. The lamination was performed under the conditions of a pressure of 0.4 MPa, a temperature of 50° C., and a laminating speed of 0.2 m/min Another lamination, using a vacuum-pressurizing laminator (MLVP-500, by Meiki Co., Ltd.), was carried out by a 30 seconds of hot-pressing at a pressure of 0.4 MPa and a temperature of 65° C. after evacuation below 500 Pa. Subsequently, ultraviolet light (wavelength 365 nm) was irradiated at a irradiation rate of 3500 mJ/cm² through a negative type photomask having apertures of 50 μm×90 mm×12 (pitch 250 μm) using an ultraviolet light exposure equipment (EXM-1172, by Orc Manufacturing Co., Ltd.) Then, removing the supporting film, etching was performed for three minutes using 1.0 wt-% of potassium carbonate aqueous solution (liquid temperature 30° C.) to remove the uncured portion of the resin for forming the core pattern and thereafter the washing was performed using 1.0% sulfuric acid and pure water. Following the washing, the core pattern having a height of 50 μm and a width of 50 μm was formed by drying and curing for one hour at 160° C.

### [Forming Upper Clad Layer 6]

After removal, from the core pattern-formed side, of the protection film on the resin film of a 75 μm-thickness thus obtained for forming the clad layer, lamination was performed, using a vacuum-pressurizing laminator (MLVP-500, by Meiki Co., Ltd.). The lamination was carried out by a 30 seconds of hot-pressing at a pressure of 0.4 MPa and a temperature of 90° C. after the evacuation below 500 Pa. Subsequently, ultraviolet light (wavelength 365 nm) was irradiated at the irradiation rate of 3000 mJ/cm² from a supporting film side of the resin film A using the ultraviolet light exposure equipment (EXM-1172, by Orc Manufacturing Co., Ltd.) After the irradiation, the supporting film was removed and then the upper clad layer 6 was formed by drying and curing for one hour at 170° C. to manufacture the optical waveguide.

### [External Form Shaping]

The core pattern of the optical waveguide obtained through the process stated above was cut together with the substrate using a dicing saw (DAC552, by DISCO Corp.) and an end-smoothing treatment was performed to manufacture the optical waveguide.

### [Measuring Optical Loss]

Light having a wavelength of 850 nm was injected from one end of the optical wave guide thus obtained using a GI50 optical fiber and the output light from the other end was received using SI144 optical fiber to measure the optical loss of the optical waveguide. The measured optical loss was 0.05 dB/cm in average. White light injected from one end of the optical wave guide thus obtained was observed at the end of the core pattern on other end. The observation showed that the brightness of the center of the core pattern was high (the brightness of the upper side and the lateral side (the area within 5 mm from the interface between the core pattern and the upper clad layer) were low). EDX measurement was conducted on the cross-section. The measurement detected potassium at the position 5 μm inside both lateral sides and upper side. The refractive index of the potassium-detected portion was 1.556 and that of the center portion of the core pattern, where potassium was not detected, was 1.558.

### Comparison Example 1

An optical waveguide was manufactured in the same manner as in the embodiment 3, except that the core pattern was formed by etching and washing was performed with 1.0% aqueous solution of calcium chloride after the etching.

### [Measuring Optical Loss]

Light having a wavelength of 850 nm was injected from one end of the optical waveguide thus obtained using a GI50 optical fiber and the output light from the other end was received using SI144 optical fiber to measure the optical loss of the optical waveguide. The measured optical loss was 0.42 dB/cm in average. White light injected from one end of the optical wave guide thus obtained was observed at the end of the core pattern on other end. The observation showed that the brightness of the center of the core pattern was low (the brightness of the core pattern in the upper side and the lateral side and their vicinity were high). EDX measurement was conducted on the cross-section. The measurement detected calcium at the position 5 μm inside both lateral sides and upper side. The refractive index of the calcium-detected portion was 1.559 and that of the center portion of the core pattern, where calcium was not detected, was 1.558. As stated above, the portion that includes divalent calcium cation has higher refractive index than that of the center portion; it was then confirmed that, unlike monovalent cation, crosslinking of the transparent member is boosted by ionic crosslinking or the like. It is therefore understood that this caused the increase in the optical propagation loss in the optical waveguide, which impeded this comparative example from exerting advantage of the effect obtained by the present invention.

### INDUSTRIAL APPLICABILITY

The method for manufacturing an optical member by the present invention is capable of providing an optical member having less position-dependent variation of the refractive index of the surface layer, including its vicinity, of the transparent member. In addition, the present invention is also capable of providing an optical waveguide having a low optical loss. Therefore, the present invention is applicable to various fields such as antireflection members, antireflection films, various optical films, various optical apparatuses, optical waveguide members, opt-electrical composite members, optical fiber cables, and optical interconnection systems.

1. A method for manufacturing an optical member comprising a Process A, wherein the Process A includes the step of exposing a transparent member to a solution to make the refractive index of the surface layer of the transparent member, which layer is exposed to the solution, substantially lower than that of the center portion of the transparent member, which center portion is not exposed to the solution.

2. A method for manufacturing an optical member according to claim 1, wherein the transparent member is impregnated with the solution when exposed to the solution in the Process A.

3. A method for manufacturing an optical member according to claim 1, wherein the solution includes a refractive index regulating agent that substantially lowers the refractive index of the surface layer of the transparent member by the solution's being included in the surface layer of the transparent member.

4. A method for manufacturing an optical member comprising a Process A′, wherein the Process A′ includes the steps of including a refractive index regulating agent that substantially lowers the refractive index of a transparent member in the surface layer of the transparent member; and thereby making the refractive index of the agent-including portion in the surface layer substantially lower than that of the center portion of the transparent member, wherein the center portion does not include the refractive index regulating agent.

5. A method for manufacturing an optical member according to claim 1, wherein the transparent member is an etchable transparent member by an etchant; the method further comprises a Process B that performs a patterning process by etching; and the Process B is performed simultaneously with the Process A or is carried out before the Process A.

6. A method for manufacturing an optical member according to claim 3, wherein the transparent member is a transparent resin; and the refractive index regulating agent is a monovalent cation.

7. A method for manufacturing an optical member according to claim 6, wherein the solution is an alkaline solution.

8. A method for manufacturing an optical member according to claim 6, wherein the monovalent cation is at least one of ions selected from the group consisting of potassium ion and sodium ion.

9. A method for manufacturing an optical member according to claim 5, wherein the transparent resin is a light-sensitive resin; and the method further comprises a Process C that performs irradiation of activation light ray with which the light-sensitive transparent resin is photocurable, wherein the Process C is carried out before the Process A or the Process B; or before the Process A and the Process B.

10. A method for manufacturing an optical member according to claim 6, wherein the method further comprises a Process D′ that thermally hardens the transparent resin after the Process A.

11. A method for manufacturing an optical member according to claim 10, where the method comprises a Process D that thermally cures a transparent resin and makes the refractive index of the surface layer, including its vicinity, of the transparent resin substantially lower than that of the center portion of the transparent resin.

12. A method for manufacturing an optical member according to claim 10, wherein the transparent resin includes at least: a base resin (A) having a thermal polymerizable functional group, and a thermal polymerizable compound (B).

13. A transparent member for forming an optical member to be used in the method for manufacturing the optical member according to the method defined in claim 1.

14. An optical member obtained by the method for manufacturing the optical member according to the method defined in claim 1.

15. An optical waveguide having a core part and a clad part, wherein the optical waveguide has a surface layer at least on a part of periphery of a core pattern that forms the core part, the surface layer having a refractive index lower than that of the center portion of the core pattern.

16. An optical waveguide according to claim 15, wherein the optical waveguide has a laminated construction comprised of a lower clad layer, the core pattern, and an upper clad layer, and the lower clad layer or the upper clad layer, or both, having a further-low refractive index is or are provided outside the surface layer having the low refractive index.

17. An optical waveguide according to claim 15, wherein the core pattern having two or more sides on the circumference thereof is such a core pattern as includes at least two sides of both the side walls.

18. An optical waveguide according to claim 16, wherein the difference in the refractive index between the low refractive index portion and the lower clad layer or the upper clad layer, or both, is larger than the difference in the refractive index between the center of the core pattern and the low refractive index portion of the circumference of the core pattern.

19. An optical waveguide according to claim 15, wherein the core pattern is formed by the transparent member for forming the optical member defined in claim 13.

20. An optical waveguide according to claim 15, wherein the surface layer includes a refractive index regulating agent for lowering the refractive index.

21. An optical module that uses the optical waveguide defined in claim 15.

22. (canceled)

23. A method for manufacturing an optical member according to claim 11, wherein the transparent resin includes at least: a base resin (A) having a thermal polymerizable functional group, and a thermal polymerizable compound (B).
